(19) United States
(12) Patent Application Publication
(10) Pub. No.: US 2016/0279767 A1
(43) Pub. Date: Sep. 29, 2016

(54) RATCHET ASSEMBLY

(71) Applicant: Ming-Ta Cheng, Taichung City (TW)

(72) Inventor: Ming-Ta Cheng, Taichung City (TW)

(21) Appl. No.: 14/670,689

(22) Filed: Mar. 27, 2015

(51) Int. Cl. B25B 13/46

(52) U.S. Cl. CPC B25B 13/465

(57) ABSTRACT

A ratchet assembly has a case, a ratchet unit, and a sleeve fixing module. The ratchet unit is mounted in the case and has a toothed surface. The sleeve fixing module is inserted in the case, engaged with the ratchet unit, and has a positioning unit, a rotating unit, a direction-reversal supporting unit, and a pawl block. The positioning unit is mounted in the case. The rotating unit is rotatably mounted in the positioning unit and has a rotating pole and a pole hole formed in the rotating pole. The direction-reversal supporting unit is mounted in the pole hole and has a socket mounted in the pole hole, a spring mounted in the socket and abutting the rotating pole, a ball rotatably mounted in the ball recess, and a pawl block pivotally mounted around the positioning unit, engaged with the ball, and engaged with the toothed surface.

### BACKGROUND OF THE INVENTION

1. Field of the Invention

The present invention relates to a ratchet, and more particularly to a ratchet assembly.

2. Description of Related Art

A ratchet wrench can be connected with a connecting sleeve, and a user can handle the ratchet wrench. The ratchet wrench comprises a ratchet unit mounted in the ratchet wrench, such that the user can use the ratchet wrench to tighten or loosen a nut or a bolt. With reference to FIG. 5, the ratchet wrench comprises a direction-reversal supporting unit 60 mounted in the ratchet wrench. The direction-reversal supporting unit 60 is integrated as a single part and comprises a semi-ball structure formed on an end of the direction-reversal supporting unit 60. The semi-ball structure is applied for turning a direction of the ratchet unit. The semi-ball structure abuts the ratchet unit when the ratchet wrench is in use. When the direction of the ratchet unit is altered continuously, the semi-ball structure is damaged due to a friction between the ratchet unit and the semi-ball structure. Therefore, after the ratchet wrench is used for a period of time, direction reversal of the ratchet unit is affected.

### BRIEF SUMMARY OF THE INVENTION

The main objective of the present invention is to provide a ratchet assembly to resolve the aforementioned problems.

The ratchet assembly comprises a case, a ratchet unit, and a sleeve fixing module.

The case is hollow and comprises a case space and two openings. The case space is formed in the case. The openings are respectively formed through two opposite sides of the case and communicate with the case space.

The ratchet unit is mounted in the case space and comprises a toothed surface.

The sleeve fixing module is inserted in the case, is engaged with the ratchet unit, and comprises a positioning unit, a rotating unit, a direction-reversal supporting unit, and a pawl block. The positioning unit is mounted in the case space and protrudes out of one of the openings of the case. The rotating unit is rotatably mounted in the positioning unit and comprises a rotating pole and a pole hole radially formed in the rotating pole. The direction-reversal supporting unit is mounted in the pole hole and comprises a socket mounted in the pole hole, a spring mounted in the socket and abutting the rotating pole, a ball rotatably mounted in the socket at a position opposite the spring, and a pawl block pivotally mounted around the positioning unit and engaged with the ball. One of two ends of the pawl block is engaged with the toothed surface of the ratchet unit.

Other objectives, advantages and novel features of the present invention will become more apparent from the following detailed description when taken in conjunction with the accompanying drawings.

### BRIEF DESCRIPTION OF THE DRAWINGS

FIG. 1 is an exploded perspective view of a preferred embodiment of a ratchet assembly in accordance with the present invention;

FIG. 2 is a partially enlarged exploded perspective view of the ratchet assembly in FIG. 1;

FIGS. 3 and 4 are operational views in partial section of the ratchet assembly in FIG. 1; and

FIG. 5 is an exploded perspective view of a direction-reversal supporting unit of a conventional ratchet wrench.

### DETAILED DESCRIPTION

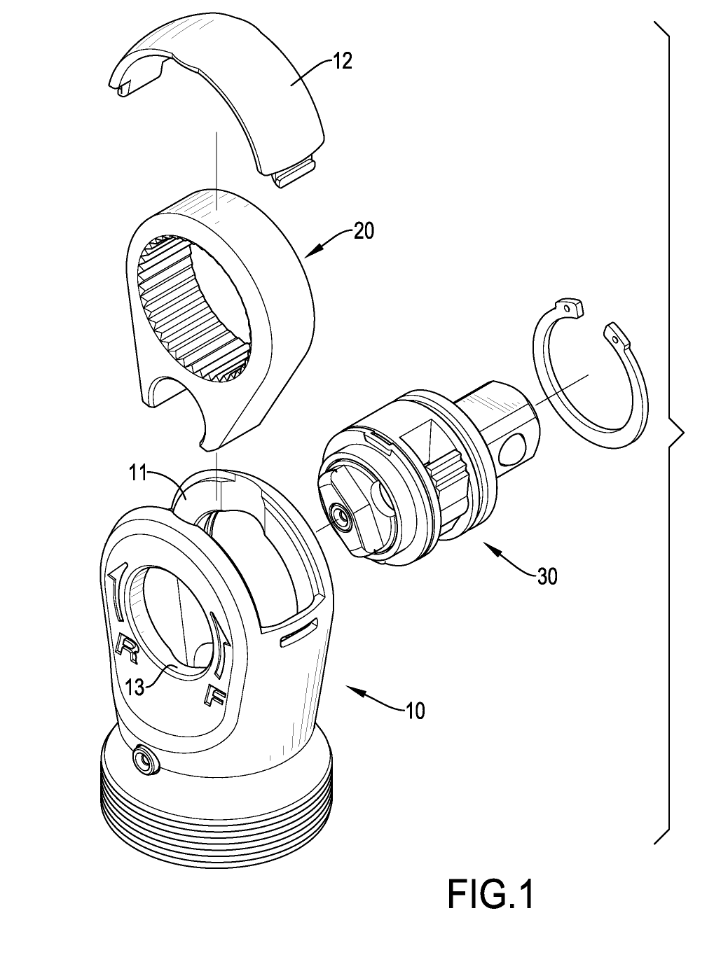

With reference to FIGS. 1 to 3, a preferred embodiment of a ratchet assembly in accordance with the present invention comprises a case 10, a ratchet unit 20, and a sleeve fixing module 30.

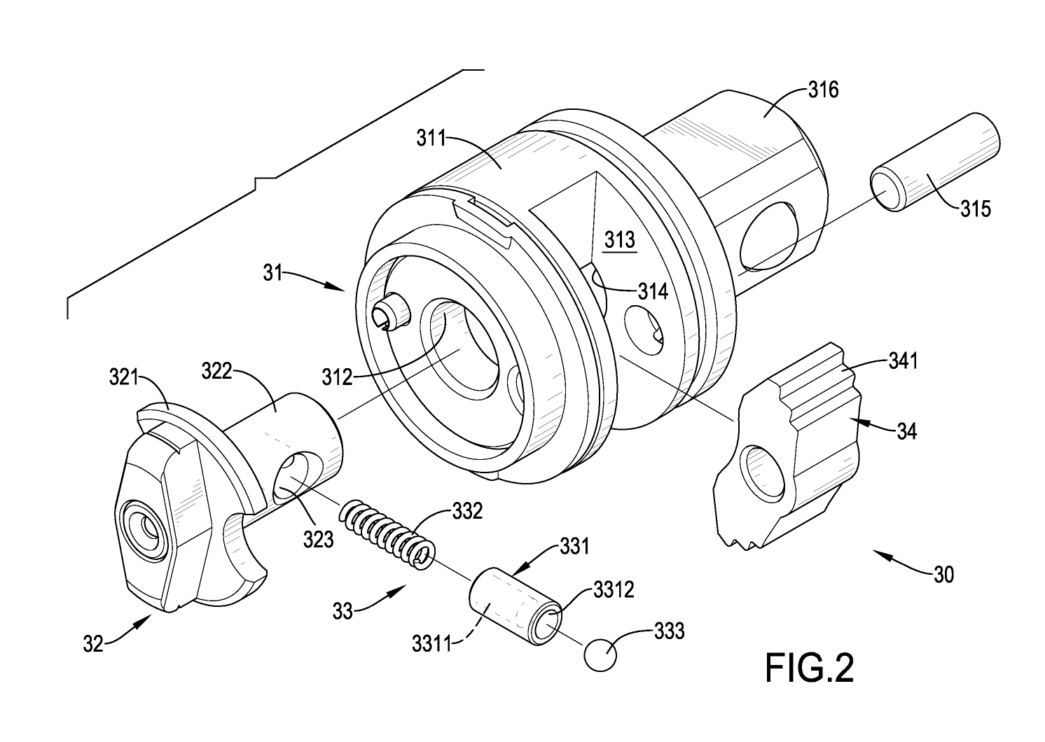

With reference to FIGS. 1 and 2, the case 10 is hollow and comprises a case space 11, a lid 12, and two openings 13. The case space 11 is formed in the case 10. The lid 12 is mounted on a top of the case 10 to close the case space 11. The openings 13 are respectively formed through a front side and a rear side of the case 10 and communicate with the case space 11.

The ratchet unit 20 is mounted in the case space 11 and comprises a toothed surface 21 annularly and inwardly formed on an inner side of the ratchet unit 20.

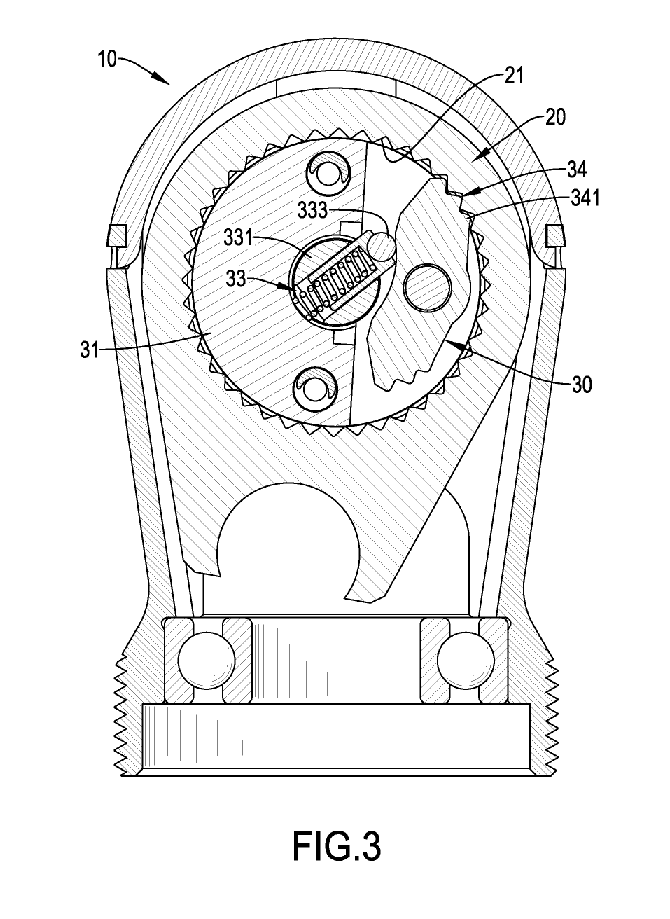

With reference to FIGS. 2 and 3, the sleeve fixing module 30 is inserted in the case 10, is engaged with the ratchet unit 20, and comprises a positioning unit 31, a rotating unit 32, a direction-reversal supporting unit 33, and a pawl block 34. The positioning unit 31 is mounted in the case space 11 and protrudes out of one of the openings 13. The positioning unit 31 comprises a rotating portion 311, an assembling hole 312, an accommodating recess 313, a connecting hole 314, a pivot pole 315, and a sleeve positioning portion 316. The rotating portion 311 is rotatably mounted in the case space 11 and protrudes out of the opening 13. An outer diameter of the positioning unit 31 differs along a longitudinal direction of the positioning unit 31. The outer diameter of the positioning unit 31 is larger at the portion that is mounted in the case space 11 than at the portion that protrudes out of the opening 13. The assembling hole 312 is formed through a middle of an end of the rotating portion 311. The accommodating recess 313 is radially formed in a side of the rotating portion 311 and communicates with the assembling hole 312. The connecting hole 314 is formed in the rotating portion 311 at a position opposite the assembling hole 312, is aligned with the assembling hole 312, and communicates with the accommodating recess 313. The pivot pole 315 is mounted through the rotating portion 311 and the accommodating recess 313. The sleeve positioning portion 316 is formed on an end of the rotating unit 311 at a position opposite the assembling hole 312. An outer diameter of the sleeve positioning portion 316 is smaller than an outer diameter of the rotating unit 311.

The rotating unit 32 is rotatably mounted in the positioning unit 31 and comprises a rotating plate 321, a rotating pole 322, and a pole hole 323. The rotating pole 322 may be hollow and is formed on a middle of a side of the rotating plate 321 and is inserted into the assembling hole 312, the accommodating recess 313, and the connecting hole 314. The rotating plate 321 rotatably abuts the rotating portion 311. The pole hole 323 is radially formed in the rotating pole 322.

The direction-reversal supporting unit 33 is mounted in the pole hole 323, protrudes out of the connecting hole 314, and comprises a socket 331, a spring 332, and a ball 333. The socket 331 may be a cylinder, is mounted in the pole hole 323, and comprises a spring recess 3311 and a ball recess 3312. The spring recess 3311 is formed in one of two ends of the socket 331. The ball recess 3312 is formed in the other end of the socket 331 at a position opposite the spring recess 3311. The spring 332 is mounted in the spring recess 3311, is inserted into the pole hole 323, and abuts between the socket 331 and the rotating pole 322. The ball 333 is rotatably mounted in the ball recess 3312. The ball 333 may be rotatably engaged with and protrudes out of the ball recess 3312.

The pawl block 34 is mounted in the accommodating recess 313, is rotatably mounted around the pivot pole 315, and comprises two ratchet surfaces 341 respectively formed on a top end and a bottom end of the pawl block 34 and selectively engaged with the toothed surface 21. The ball 333 abuts a side of the pawl block 34 since the socket 331 is abutted by the spring 332 to push the ball 333.

With reference to FIG. 3, in use, the direction-reversal supporting unit 33 of the sleeve fixing module 30 abuts the side of the pawl block 34, such that one of the ratchet surfaces 341 can be engaged with the toothed surface 21. When the ratchet assembly is rotated in a clockwise direction, the ratchet surface 341 formed on the top end of the pawl block 34 abuts the toothed surface 21. Therefore, when the positioning unit 31 is rotated in the clockwise direction, the pawl block 34 can be engaged with the ratchet unit 20. When the pawl block 34 abuts the ball 333, the ball 333 can be kept from being damaged since the ball 33 is rotatable. A contact surface between the ball 333 and the pawl block 34 differs along with a rotation of the ball 333, such that a surface of the ball 333 can be kept from being damaged due to repeated friction at a same position of the ball 333, and a use life of the ball 333 can be prolonged effectively.

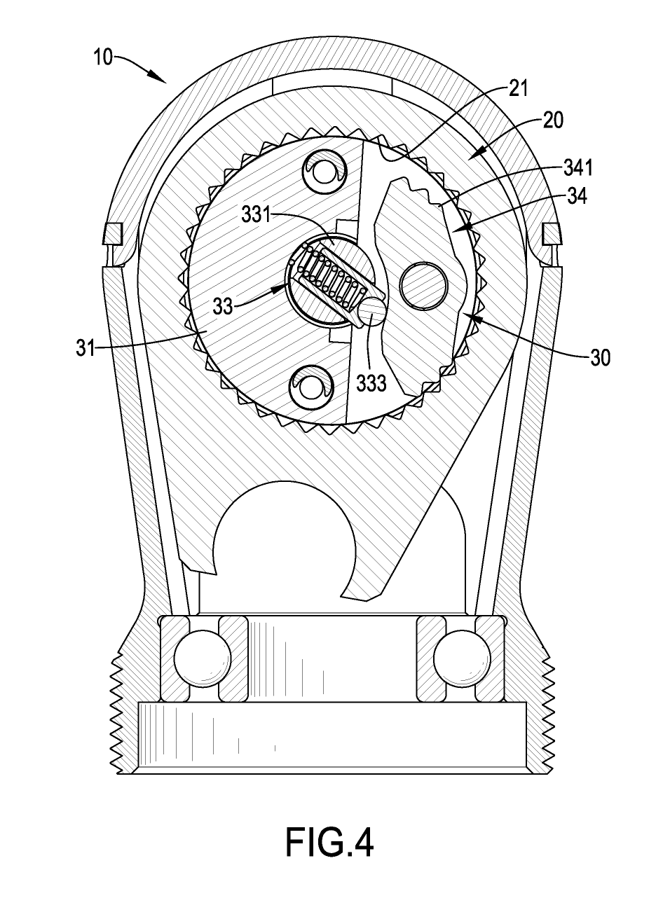

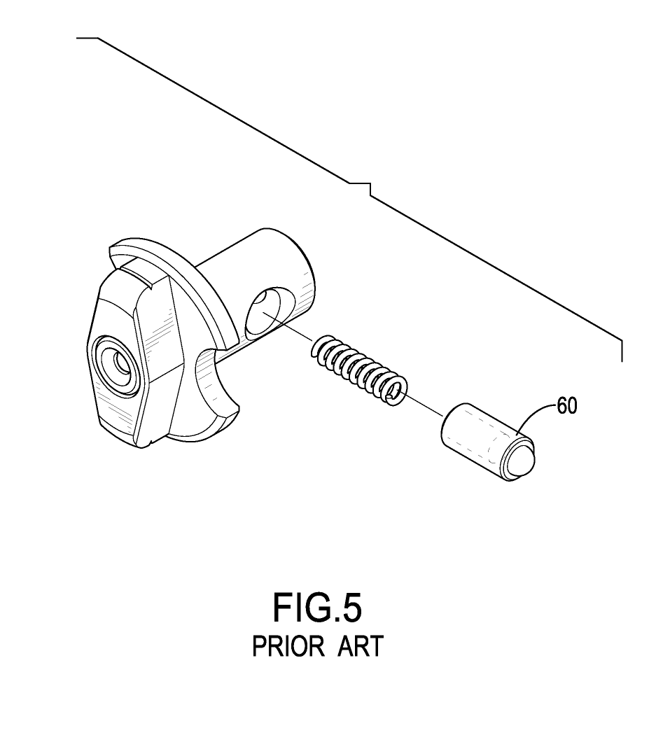

With reference to FIG. 4, when the rotating unit 32 is rotated, the direction-reversal supporting unit 33 can abut the pawl block 34 at a position adjacent to the bottom end of the pawl block 34. The ratchet surface 341 formed on the bottom end of the pawl block 34 abuts the toothed surface 21, and the pawl block 34 can be engaged with the toothed surface 21 in a counterclockwise direction.

From the above description, it is noted that the present invention has the following advantages: the ball 333 is rotatably mounted in the socket 331, such that the contact surface between the ball 333 and the pawl block 34 differs along the rotation of the ball 333. The ball 333 can be kept from being damaged due to repeated friction at the same position of the ball 333, and the use life of the ratchet assembly can be prolonged effectively. Furthermore, when the ball 333 needs to be replaced, the ball 333 can be replaced individually without replacing the overall sleeve fixing module 30.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A ratchet assembly comprising:
a case being hollow and comprising
a case space formed in the case; and
two openings respectively formed through two opposite sides of the case and communicating with the case space;
a ratchet unit mounted in the case space and comprising a toothed surface; and
a sleeve fixing module inserted in the case, engaged with the ratchet unit, and comprising
a positioning unit mounted in the case space and protruding out of one of the openings of the case;
a rotating unit rotatably mounted in the positioning unit and comprising a rotating pole and a pole hole radially formed in the rotating pole;
a direction-reversal supporting unit mounted in the pole hole and comprising
a socket mounted in the pole hole;
a spring mounted in the socket and abutting the rotating pole;
a ball rotatably mounted in the socket at a position opposite the spring;
a pawl block pivotally mounted in the positioning unit and abutting the ball, and one of two ends of the pawl block engaged with the toothed surface of the ratchet unit.

2. The ratchet assembly as claimed in claim 1, wherein the socket further comprises a ball recess formed in an end of the socket, and the ball is rotatably mounted in the ball recess.

3. The ratchet assembly as claimed in claim 1, wherein
the positioning unit further comprises a rotating portion;
the positioning unit further comprises an assembling hole formed in a middle of an end of the rotating portion, and the rotating pole is inserted into the assembling hole; and
the rotating unit further comprises a rotating plate connected with the rotating pole and rotatably abutting the rotating portion, and the rotating pole is hollow.

4. The ratchet assembly as claimed in claim 2, wherein
the positioning unit further comprises a rotating portion, and an outer diameter of the rotating portion differs along a longitudinal direction of the rotating portion to form a step structure;
the positioning unit further comprises an assembling hole formed in a middle of an end of the rotating portion, and the rotating pole is inserted into the assembling hole; and
the rotating unit further comprises a rotating plate connected with the rotating pole and rotatably abutting the rotating portion, and the rotating pole is hollow.

5. The ratchet assembly as claimed in claim 3, wherein the positioning unit further comprises
an accommodating recess radially formed in a side of the rotating portion; and
a pivot pole mounted through the rotating portion and the accommodating recess, wherein the pawl block is mounted in the accommodating recess and is rotatably mounted around the pivot pole.

6. The ratchet assembly as claimed in claim 4, wherein the positioning unit further comprises
an accommodating recess radially formed in a side of the rotating portion; and
a pivot pole mounted through the rotating portion and the accommodating recess, wherein the pawl block is mounted in the accommodating recess and is pivotally mounted around the pivot pole.
